(19) United States
(12) Patent Application Publication
(10) Pub. No.: US 2026/0170798 A1
(43) Pub. Date: Jun. 18, 2026

(54) HAZARD INFORMATION MANAGEMENT SERVER FOR COLLECTING AND MANAGING HAZARD INFORMATION ON ROAD THROUGH LINK WITH INFORMATION COLLECTING TERMINAL MOUNTED ON VEHICLE, AND OPERATING METHOD THEREOF

(71) Applicant: DAREESOFT INC., Seongnam-si (KR)

(72) Inventors: Jaemin NOH, Seongnam-si (KR); Mansik JEONG, Seongnam-si (KR); Elizabath Kim ROW, Seongnam-si (KR)

(73) Assignee: DAREESOFT INC., Seongnam-si (KR)

(21) Appl. No.: 18/725,381

(22) PCT Filed: Aug. 5, 2022
(86) PCT No.: PCT/KR2022/011710

§ 371 Date: Jan. 31, 2025

(30) Foreign Application Priority Data
Dec. 30, 2021 (KR) 10-2021-0192893

(51) Int. Cl. G06V 10/75; G06V 10/26; G06V 10/50; G06V 10/56; G06V 10/74; G06V 20/56; H04L 9/40

(52) U.S. Cl. CPC G06V 10/758; G06V 10/26; G06V 10/507; G06V 10/56; G06V 10/761; G06V 20/56; H04L 63/0428

(57) ABSTRACT

There is disclosed a dangerous goods information management server that can collect and manage dangerous goods information on the road through interworking with an information collection terminal mounted on a vehicle, and an operation method thereof. The present disclosure can support dangerous goods informations received from an information collection terminal to be managed more efficiently by providing a technology that can determine whether there is an overlap between the dangerous goods informations received from the information collection terminal mounted on a vehicle.

### TECHNICAL FIELD

The present disclosure relates to a dangerous goods information management server that can collect and manage dangerous goods information on the road through interworking with an information collection terminal mounted on a vehicle, and an operation method thereof.

### BACKGROUND ART

On the road, there are dangerous goods, for example, falling loads, road damage, such as potholes which are local holes formed as a part of the road surface is broken or collapsed, or pavement cracks, etc. If these dangerous goods appear in an unexpected situation while a driver is driving a vehicle, it is difficult for the driver to respond appropriately, such as slowing down the speed of the vehicle or changing a direction of travel to avoid the dangerous goods, thereby increasing the risk of a traffic accident.

In this regard, in recent years, in order to support drivers to drive more safely by providing dangerous goods information to the drivers in advance, studies have been actively carried out on technology in which a vehicle equipped with an information collection terminal collects dangerous goods information including captured images of dangerous goods on the road and location information where the captured images are taken, and stores the dangerous goods information in a database.

In order to efficiently operate a storage space of the database for storing the dangerous goods information and to provide the accurate dangerous goods information to the drivers, it is necessary to manage the dangerous goods informations stored in the database so that the dangerous goods informations do not overlap with each other.

In this regard, when new dangerous goods information is received from the information collection terminal mounted on the vehicle, before additionally storing the new dangerous goods information in the database, if a technology is introduced that can determine whether the new dangerous goods information overlaps with the dangerous goods informations stored in the database, it is possible to manage the dangerous goods informations stored in the database so that they do not overlap with each other.

Accordingly, there is a need for research on the technology that can determine whether there is an overlap between the dangerous goods informations received from the information collection terminal mounted on the vehicle.

### Disclosure

### Technical Problem

The present disclosure provides a dangerous goods information management server that can determine whether there is an overlap between dangerous goods informations received from an information collection terminal mounted on a vehicle, and an operation method thereof, thereby supporting the dangerous goods informations received from the information collection terminal to be managed more efficiently.

### Technical Solution

A dangerous goods information management server that collects and manages dangerous goods information on a road through interworking with an information collection terminal mounted on a vehicle according to an embodiment of the present disclosure comprises a dangerous goods information database configured to store dangerous goods informations collected by a plurality of vehicles pre-designated to collect dangerous goods information on the road, each of the dangerous goods informations including captured images of dangerous goods on the road captured through the information collection terminal mounted on the vehicle, and location information where the captured images are taken, each of the plurality of vehicles being equipped with the information collection terminal provided with a camera that is able to capture a front of each vehicle in order to collect the dangerous goods information on the road; an overlap determination unit configured to determine whether the dangerous goods informations stored in the dangerous goods information database include dangerous goods information overlapping with first dangerous goods information when the first dangerous goods information, including a first captured image of a first dangerous goods captured on the road by a first information collection terminal and first location information where the first captured image is taken, is received from the first information collection terminal mounted on a first vehicle which is any one of the plurality of vehicles; and a dangerous goods information processing unit configured to additionally store the first dangerous goods information in the dangerous goods information database when it is checked that the dangerous goods informations stored in the dangerous goods information database do not include the dangerous goods information overlapping with the first dangerous goods information, and discard the first dangerous goods information when it is checked that the dangerous goods informations stored in the dangerous goods information database include the dangerous goods information overlapping with the first dangerous goods information.

An operation method of a dangerous goods information management server that collects and manages dangerous goods information on a road through interworking with an information collection terminal mounted on a vehicle according to an embodiment of the present disclosure comprises maintaining a dangerous goods information database configured to store dangerous goods informations collected by a plurality of vehicles pre-designated to collect dangerous goods information on the road, each of the dangerous goods informations including captured images of dangerous goods on the road captured through the information collection terminal mounted on the vehicle, and location information where the captured images are taken, each of the plurality of vehicles being equipped with the information collection terminal provided with a camera that is able to capture a front of each vehicle in order to collect the dangerous goods information on the road; determining whether the dangerous goods informations stored in the dangerous goods information database include dangerous goods information overlapping with first dangerous goods information when the first dangerous goods information, including a first captured image of a first dangerous goods captured on the road by a first information collection terminal and first location information where the first captured image is taken, is received from the first information collection terminal mounted on a first vehicle which is any one of the plurality of vehicles; and additionally storing the first dangerous goods information in the dangerous goods information database when it is checked that the dangerous goods informations stored in the dangerous goods information database do not include the dangerous goods information overlapping with the first dangerous goods information, and discarding the first dangerous goods information when it is checked that the dangerous goods informations stored in the dangerous goods information database include the dangerous goods information overlapping with the first dangerous goods information.

### Advantageous Effects

The present disclosure can support dangerous goods informations received from an information collection terminal to be managed more efficiently by providing a dangerous goods information management server that can determine whether there is an overlap between the dangerous goods informations received from the information collection terminal mounted on a vehicle, and an operation method thereof.

### DESCRIPTION OF DRAWINGS

FIG. 1 illustrates a structure of a dangerous goods information management server capable of collecting and managing dangerous goods information on the road through interworking with an information collection terminal mounted on a vehicle according to an embodiment of the present disclosure.

FIG. 2 illustrates an operation of a dangerous goods information management server capable of collecting and managing dangerous goods information on the road through interworking with an information collection terminal mounted on a vehicle according to an embodiment of the present disclosure.

FIG. 3 is a flowchart illustrating an operation method of a dangerous goods information management server capable of collecting and managing dangerous goods information on the road through interworking with an information collection terminal mounted on a vehicle according to an embodiment of the present disclosure.

### MODE FOR INVENTION

Reference will now be made in detail to embodiments of the present disclosure, examples of which are illustrated in the accompanying drawings. This description is not intended to limit the present disclosure to a particular form of implementation, and the present disclosure should be understood to include all modifications, equivalents or substitutes included in the scope of sprit and idea of the present disclosure. Similar reference numerals have been used for similar components in describing each drawing, and unless otherwise defined, all terms used in the present disclosure, including technical or scientific terms, have the same meaning as would be generally understood by the person of ordinary skill in the art to which the present disclosure pertains.

In the present disclosure, when a part “includes” a component, it means that it may further include other components, not exclude the other components, unless specifically stated otherwise. In addition, in various embodiments of the present disclosure, each component, functional block or means may include one or more sub-components. Further, electrical, electronic, and mechanical functions performed by each component may be implemented as known various elements or mechanical elements such as an electronic circuit, an integrated circuit, an application specific integrated circuit (ASIC), or may be implemented separately or may be integrated into one and implemented.

Blocks of a block diagram or steps of a flowchart in the accompanying drawings may be interpreted to mean computer program instructions that are mounted on a processor or memory of a device capable of data processing, such as a general-purpose computer, a special-purpose computer, a portable notebook computer, and a network computer, and perform specified functions. Since the computer program instructions can be stored in a memory included in a computer server or in a computer readable memory, functions described in the blocks of the block diagram or the steps of the flowchart may be produced as a product containing a command means to perform the instructions. In addition, each block or each step may represent a module, segment, or part of code including one or more executable instructions for executing specified logical function(s). In some alternative embodiments, it should be noted that it is possible for the functions mentioned in the blocks or the steps to be executed in a different order from a predetermined order. For example, two consecutively illustrated blocks or steps may be performed substantially simultaneously or performed in reverse order, and in some cases some blocks or steps may be omitted.

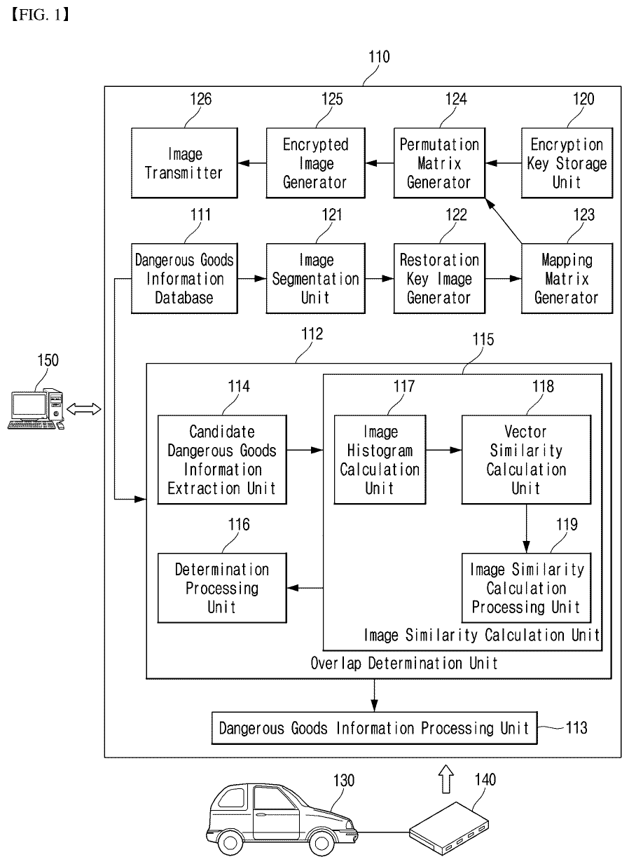

FIG. 1 illustrates a structure of a dangerous goods information management server capable of collecting and managing dangerous goods information on the road through interworking with an information collection terminal mounted on a vehicle according to an embodiment of the present disclosure.

Referring to FIG. 1, a dangerous goods information management server 110 according to an embodiment of the present disclosure includes a dangerous goods information database 111, an overlap determination unit 112, and a dangerous goods information processing unit 113.

The dangerous goods information database 111 stores dangerous goods informations (each of the dangerous goods informations includes captured images of dangerous goods on the road captured through an information collection terminal mounted on a vehicle, and location information where the captured images are taken) collected by a plurality of vehicles (each of the plurality of vehicles is equipped with an information collection terminal provided with a camera that can capture the front of each vehicle in order to collect dangerous goods information on the road) pre-designated to collect dangerous goods information on the road.

The dangerous goods informations stored in the dangerous goods information database 111 may be dangerous goods informations generated by the information collection terminal obtained as drivers driving the plurality of vehicles identify dangerous goods on the road with the naked eye and apply information collection instructions to the information collection terminal mounted on each vehicle, or may be dangerous goods informations automatically generated by the information collection terminal obtained as the information collection terminal automatically detects dangerous goods on the road based on a dangerous goods detection model (the dangerous goods detection model is a predetermined artificial intelligence (AI)-based dangerous goods detection model for detecting dangerous goods based on images captured through the camera) pre-installed in the information collection terminal.

In this regard, the dangerous goods information database 111 may store the dangerous goods informations collected by the plurality of vehicles pre-designated to collect the dangerous goods information on the road, as shown in Table 1 below.

TABLE 1

| Dangerous Goods | | |
|---|---|---|
| Information | Captured Image | Location Information |
| Dangerous Goods | Captured Image 1 | Location Information 1 |
| Information 1 | | |
| Dangerous Goods | Captured Image 2 | Location Information 2 |
| Information 2 | | |
| Dangerous Goods | Captured Image 3 | Location Information 3 |
| Information 3 | | |
| Dangerous Goods | Captured Image 4 | Location Information 4 |
| Information 4 | | |
| Dangerous Goods | Captured Image 5 | Location Information 5 |
| Information 5 | | |

When first dangerous goods information (including a first captured image of a first dangerous goods captured on the road by a first information collection terminal 140 and first location information where the first captured image is taken) is received from the first information collection terminal 140 mounted on a first vehicle 130 which is any one of the plurality of vehicles, the overlap determination unit 112 determines whether the dangerous goods informations stored in the dangerous goods information database 111 include dangerous goods information overlapping with the first dangerous goods information.

According to an embodiment of the present disclosure, the overlap determination unit 112 may include a candidate dangerous goods information extraction unit 114, an image similarity calculation unit 115, and a determination processing unit 116, in order to determine whether the dangerous goods informations stored in the dangerous goods information database 111 include dangerous goods information overlapping with the first dangerous goods information.

When the first dangerous goods information is received from the first information collection terminal 140, the candidate dangerous goods information extraction unit 114 extracts at least one candidate dangerous goods information including location information, in which a separation distance from the first location information is within a preset reference distance, from the dangerous goods informations stored in the dangerous goods information database 111.

For example, it is assumed that the dangerous goods information management server 110 has received ‘dangerous goods information 6’ from the first information collection terminal 140 mounted on the first vehicle 130 which is any one of the plurality of vehicles.

Here, it is assumed that the ‘dangerous goods information 6’ includes a ‘captured image 6’ which is the first captured image of the first dangerous goods captured on the road by the first information collection terminal 140, and ‘location information 6’ which is the first location information where the ‘captured image 6’ is captured.

When the preset reference distance is ‘10 m’, the candidate dangerous goods information extraction unit 114 may extract at least one candidate dangerous goods information including location information, in which a separation distance from the ‘location information 6’ is within ‘10 m’, from the dangerous goods informations stored in the dangerous goods information database 111, as shown in Table 1 above.

In this regard, the candidate dangerous goods information extraction unit 114 may compare each of ‘location information 1, location information 2, location information 3, location information 4, and location information 5’, that are included in the dangerous goods informations stored in the dangerous goods information database 111 shown in Table 1 above, with the ‘location information 6’ and check whether a separation distance between each of ‘the location information 1, the location information 2, the location information 3, the location information 4, and the location information 5’ and the ‘location information 6’ is within ‘10 m’. As a result, if it is checked that the separation distance of ‘the location information 2 and the location information 5’ among ‘the location information 1, the location information 2, the location information 3, the location information 4, and the location information 5’ from the ‘location information 6’ is within ‘10 m’, the candidate dangerous goods information extraction unit 114 may extract ‘dangerous goods information 2 and dangerous goods information 5’ which are dangerous goods information including ‘the location information 2 and the location information 5’, as the at least one candidate dangerous goods information, from the dangerous goods informations stored in the dangerous goods information database 111, as shown in the Table 1.

If the at least one candidate dangerous goods information is extracted by the candidate dangerous goods information extraction unit 114 as above, the image similarity calculation unit 115 may calculate an image similarity between a captured image included in each of the at least one candidate dangerous goods information and the first captured image to calculate an image similarity corresponding to each of the at least one candidate dangerous goods information.

In this instance, according to an embodiment of the present disclosure, the image similarity calculation unit 115 may include an image histogram calculation unit 117, a vector similarity calculation unit 118, and an image similarity calculation processing unit 119, in order to calculate an image similarity corresponding to each of the at least one candidate dangerous goods information.

When the at least one candidate dangerous goods information is extracted by the candidate dangerous goods information extraction unit 114, the image histogram calculation unit 117 calculates an image histogram for each color channel for each of a captured image included in each of the at least one candidate dangerous goods information and the first captured image.

Here, the image histogram refers to a graph consisting of a horizontal axis representing pixel value and a vertical axis representing the number of pixels, in order to indicate characteristics of an image. This may be configured for each color channel, such as RGB (Red, Green, Blue), CMYK (Cyan, Magenta, Yellow, black), etc., based on a color mode of the image.

When the image histogram calculation unit 117 calculates the image histogram for each color channel for each of the captured image included in each of the at least one candidate dangerous goods information and the first captured image, the vector similarity calculation unit 118 calculates a vector similarity for each color channel between a vector having, as a component, the number of pixels per pixel value included in an image histogram for the captured image included in each of the at least one candidate dangerous goods information and a vector having, as a component, the number of pixels per pixel value included in an image histogram for the first captured image to thereby calculate a vector similarity for each color channel of each of the at least one candidate dangerous goods information.

Here, the vector similarity may use cosine similarity according to Equation 1 below or Euclidean Distance according to Equation 2 below.

$$S = \frac{{\sum }_{i = 1}^{n} {A}_{i} \times {B}_{i}}{\sqrt{{\sum }_{i = 1}^{n} {( {A}_{i} )}^{2}} \times \sqrt{{\sum }_{i = 1}^{n} {( {B}_{i} )}^{2}}} \qquad [ Equation 1 ]$$

In the Equation 1 above, S is cosine similarity between vector A and vector B and has a value between −1 and 1, Aᵢ is an i-th component of the vector A, and Bᵢ is an i-th component of the vector B. In this regard, the greater the cosine similarity between the two vectors, the more similar the two vectors may be seen.

$$D = \sqrt{{\sum }_{i = 1}^{n} {( {A}_{i} - {B}_{i} )}^{2}} \qquad [ Equation 2 ]$$

In the Equation 2 above, D is Euclidean Distance between vector A and vector B, Aᵢ is an i-th component of the vector A, and Bᵢ is an i-th component of the vector B. In this regard, the smaller the Euclidean Distance between the two vectors, the more similar the two vectors may be seen.

When the vector similarity calculation unit 118 calculates the vector similarity for each color channel of each of the at least one candidate dangerous goods information, the image similarity calculation processing unit 119 calculates an average value of the vector similarity for each color channel of each of the at least one candidate dangerous goods information using the image similarity between the captured image included in each candidate dangerous goods information and the first captured image to thereby calculate the image similarity corresponding to each of the at least one candidate dangerous goods information.

The operations of the image histogram calculation unit 117, the vector similarity calculation unit 118, and the image similarity calculation processing unit 119 are described in detail below, by way of example.

As described above, it is first assumed that ‘the location information 2 and the location information 5’ are extracted as the at least one candidate dangerous goods information by the candidate dangerous goods information extraction unit 114.

In this instance, referring to the dangerous goods information database 111 shown in Table 1 above, since the captured images included in ‘the location information 2 and the location information 5’ are captured image 2 and captured image 5, respectively, the image histogram calculation unit 117 may calculate an image histogram for each color channel for ‘the captured image 2 and the captured image 5’ and ‘the captured image 6’ which is the first captured image, as shown in Table 2 below, if the color channel is configured as RGB.

TABLE 2

Image Histogram

| Captured Image | R (Red) | G (Green) | B (Blue) |
|---|---|---|---|
| Captured Image 2 | Histogram 1 | Histogram 2 | Histogram 3 |
| Captured Image 5 | Histogram 4 | Histogram 5 | Histogram 6 |
| Captured Image 6 | Histogram 7 | Histogram 8 | Histogram 9 |

Then, the vector similarity calculation unit 118 may calculate a vector similarity for each color channel between a vector having, as a component, the number of pixels per pixel value included in an image histogram for each of ‘the captured image 2 and the captured image 5’ and a vector having, as a component, the number of pixels per pixel value included in an image histogram for ‘the captured image 6’ to thereby calculate a vector similarity for each color channel for each of ‘the dangerous goods information 2 and the dangerous goods information 5’.

In this regard, a process in which the vector similarity calculation unit 118 calculates a vector similarity for each color channel for ‘the dangerous goods information 2’ among ‘the dangerous goods information 2 and the dangerous goods information 5’ is described in detail as follows.

First, referring to Table 2 above, an image histogram for each color channel for ‘the captured image 2’ is ‘histogram 1, histogram 2, and histogram 3’, and an image histogram for each color channel for ‘the captured image 6’ is ‘histogram 7, histogram 8, and histogram 9’. Therefore, the vector similarity calculation unit 118 can calculate a vector similarity between a vector having, as a component, the number of pixels per pixel value included in the ‘histogram 1’ and a vector having, as a component, the number of pixels per pixel value included in the ‘histogram 7’ to thereby calculate a vector similarity S₁ for the color channel R of ‘the dangerous goods information 2’. Further, the vector similarity calculation unit 118 can calculate a vector similarity between a vector having, as a component, the number of pixels per pixel value included in the ‘histogram 2’ and a vector having, as a component, the number of pixels per pixel value included in the ‘histogram 8’ to thereby calculate a vector similarity S₂ for the color channel G of ‘the dangerous goods information 2’. Finally, the vector similarity calculation unit 118 can calculate a vector similarity between a vector having, as a component, the number of pixels per pixel value included in the ‘histogram 3’ and a vector having, as a component, the number of pixels per pixel value included in the ‘histogram 9’ to thereby calculate a vector similarity S₃ for the color channel B of ‘the dangerous goods information 2’. As described above, the vector similarity calculation unit 118 can calculate the vector similarity between the histograms for each of the color channels R, G and B to thereby calculate the vector similarities S₁, S₂ and S₃ for each color channel for ‘the dangerous goods information 2’.

In this way, the vector similarity calculation unit 118 can calculate the vector similarity for each color channel for each of ‘the dangerous goods information 2 and the dangerous goods information 5’ as shown in Table 3 below.

TABLE 3

| | Vector similarity for | | |
|---|---|---|---|
| At least one candidate dangerous | each color channel | | |
| goods information | R (Red) | G (Green) | B (Blue) |
| Dangerous goods information 2 | S₁ | S₂ | S₃ |
| Dangerous goods information 5 | S₄ | S₅ | S₆ |

Then, the image similarity calculation processing unit 119 can calculate an average value of the vector similarity for each color channel for each of ‘the dangerous goods information 2 and the dangerous goods information 5’ using the image similarity between ‘the captured image 2 and the captured image 5’ included in each candidate dangerous goods information and ‘the captured image 6’ to thereby calculate the image similarity corresponding to each of ‘the dangerous goods information 2 and the dangerous goods information 5’.

In this regard, referring to Table 3 above, since the vector similarity for each color channel for ‘the dangerous goods information 2’ is S₁, S₂ and S₃, the image similarity calculation processing unit 119 can calculate an average value ‘

$$\frac{{S}_{1} + {S}_{2} + {S}_{3}}{3} ,$$

of S₁, S₂ and S₃ using the image similarity between ‘the captured image 2’ and ‘the captured image 6’ to thereby calculate the image similarity corresponding to ‘the dangerous goods information 2’ as

$$‘ \frac{{S}_{1} + {S}_{2} + {S}_{3}}{3} ’ .$$

Further, since the vector similarity for each color channel for ‘the dangerous goods information 5’ is S₄, S₅ and S₆, the image similarity calculation processing unit 119 can calculate an average value

$$‘ \frac{{S}_{4} + {S}_{5} + {S}_{6}}{3} ’$$

of S₄, S₅ and S₆ using the image similarity between ‘the captured image 5’ and ‘the captured image 6’ to thereby calculate the image similarity corresponding to ‘the dangerous goods information 5’ as

$$‘ \frac{{S}_{4} + {S}_{5} + {S}_{6}}{3} ’ .$$

According to another embodiment of the present disclosure, the dangerous goods information management server 110 may use a method of calculating an image similarity between captured images using a pre-built artificial intelligence (AI) based image similarity calculation model, in addition to the above-described method of calculating an image similarity through comparison of image histograms, as the method for calculating an image similarity between captured images. That is, the dangerous goods information management server 110 may calculate image similarity between the captured image included in the at least one dangerous goods information and the first captured image using a predetermined AI based image similarity calculation model to calculate image similarity corresponding to each of the at least one candidate dangerous goods information.

If the image similarity corresponding to each of the at least one candidate dangerous goods information is calculated by the image similarity calculation unit 115 as above, the determination processing unit 116 checks whether the image similarity corresponding to each of the at least one candidate dangerous goods information exceeds a preset reference similarity. If it is checked that the image similarity corresponding to each of the at least one candidate dangerous goods information includes an image similarity exceeding the reference similarity, the determination processing unit 116 determines that the dangerous goods informations stored in the dangerous goods information database 111 include dangerous goods information overlapping with the first dangerous goods information. If it is checked that the image similarity corresponding to each of the at least one candidate dangerous goods information does not include the image similarity exceeding the reference similarity, the determination processing unit 116 determines that the dangerous goods informations stored in the dangerous goods information database 111 do not include dangerous goods information overlapping with the first dangerous goods information.

If it is checked that the dangerous goods informations stored in the dangerous goods information database 111 do not include the dangerous goods information overlapping with the first dangerous goods information, the dangerous goods information processing unit 113 additionally stores the first dangerous goods information in the dangerous goods information database 111. If it is checked that the dangerous goods informations stored in the dangerous goods information database 111 include the dangerous goods information overlapping with the first dangerous goods information, the dangerous goods information processing unit 113 discards the first dangerous goods information.

The operations of the determination processing unit 116 and the dangerous goods information processing unit 113 are described in detail below, by way of example.

First, it is assumed that the preset reference similarity is ‘0.9’, and the image similarities corresponding to each of ‘the dangerous goods information 2 and the dangerous goods information 5’ which are the at least one candidate dangerous goods information are calculated as

$$‘ \frac{{S}_{1} + {S}_{2} + {S}_{3}}{3} , \frac{{S}_{4} + {S}_{5} + {S}_{6}}{3} ’$$

by the image similarity calculation processing unit 119 as in the above-described example.

Then, the determination processing unit 116 may check whether the image similarities

$$‘ \frac{{S}_{1} + {S}_{2} + {S}_{3}}{3} , \frac{{S}_{4} + {S}_{5} + {S}_{6}}{3} ’$$

corresponding to each of ‘the dangerous goods information 2 and the dangerous goods information 5’ exceed the reference similarity of ‘0.9’.

If it is checked that

$$‘ \frac{{S}_{4} + {S}_{5} + {S}_{6}}{3} ’ among ‘ \frac{{S}_{1} + {S}_{2} + {S}_{3}}{3} , \frac{{S}_{4} + {S}_{5} + {S}_{6}}{3} ’$$

exceeds ‘0.9’, the determination processing unit 116 may determine that the dangerous goods informations stored in the dangerous goods information database 111 as shown in Table 1 include dangerous goods information overlapping with ‘the dangerous goods information 6’ which is the first dangerous goods information.

Then, the dangerous goods information processing unit 113 may discard ‘the dangerous goods information 6’ and may process not to additionally store the dangerous goods information overlapping with the dangerous goods informations stored in the dangerous goods information database 111 shown in Table 1.

On the other hand, as a result that the determination processing unit 116 checks whether the image similarities

$$‘ \frac{{S}_{1} + {S}_{2} + {S}_{3}}{3} , \frac{{S}_{4} + {S}_{5} + {S}_{6}}{3} ’$$

corresponding to each of ‘the dangerous goods information 2 and the dangerous goods information 5’ exceed the reference similarity of ‘0.9’, if it is checked that both the image similarities

$$‘ \frac{{S}_{1} + {S}_{2} + {S}_{3}}{3} , \frac{{S}_{4} + {S}_{5} + {S}_{6}}{3} ’$$

do not exceed the reference similarity of ‘0.9’, the determination processing unit 116 may determine that the dangerous goods informations stored in the dangerous goods information database 111 shown in Table 1 do not include dangerous goods information overlapping with ‘the dangerous goods information 6’ which is the first dangerous goods information.

Then, the dangerous goods information processing unit 113 may additionally store ‘the dangerous goods information 6’ in the dangerous goods information database 111 shown in Table 1.

According to an embodiment of the present disclosure, if a request for provision of second dangerous goods information which is any one of the dangerous goods informations stored in the dangerous goods information database 111 is received from a manager terminal 150, the dangerous goods information management server 110 may further include an encryption key storage unit 120, an image segmentation unit 121, a restoration key image generator 122, a mapping matrix generator 123, a permutation matrix generator 124, an encrypted image generator 125, and an image transmitter 126, in order to encrypts the second dangerous goods information and transmit it to the manager terminal 150.

The encryption key storage unit 120 stores an encryption key that is pre-shared with the manager terminal 150.

For example, when the encryption key pre-shared with the manager terminal 150 is referred to as ‘encryption key 1’, the encryption key storage unit 120 may store the ‘encryption key 1’.

If a request for provision of second dangerous goods information which is any one of the dangerous goods informations stored in the dangerous goods information database 111 is received from the manager terminal 150, the image segmentation unit 121 extracts the second dangerous goods information from the dangerous goods information database 111 and segments a second captured image included in the second dangerous goods information into nxn partial regions including n horizontal regions and n vertical regions, where n is a natural number greater than or equal to 2.

The restoration key image generator 122 randomly selects k first partial regions from among the nxn partial regions constituting the second captured image, where k is a natural number greater than or equal to 2 and less than n², and randomly selects an odd number of first pixels for each of the first partial regions. Then, the restoration key image generator 122 randomly changes a pixel value for each of the first pixels selected for each of the first partial regions and randomly selects an even number of second pixels for each of remaining (n²-k) second partial regions excluding the first partial regions from the nxn partial regions. Then, the restoration key image generator 122 randomly changes a pixel value for each of the second pixels selected for each of the second partial regions to thereby generate a restoration key image.

When the restoration key image is generated by the restoration key image generator 122, the mapping matrix generator 123 allocates an element of ‘1’ to the same points as the first partial regions among the nxn partial regions and allocates an element of ‘0’ to the same points as the second partial regions to thereby generate a mapping matrix of size n×n including ‘0’ and ‘1’. [79] When the mapping matrix is generated by the mapping matrix generator 123, the permutation matrix generator 124 splits data for second location information included in the second dangerous goods information into k pieces to generate k pieces of split data, and randomly generates (n²-k) dummy data. Then, the permutation matrix generator 124 inserts the k split data one by one at points, at which the elements of ‘1’ among the nxn elements constituting the mapping matrix are located, and inserts the (n²-k) dummy data one by one at points, at which the elements of ‘0’ are located, to thereby generate a permutation matrix of size n×n.

The encrypted image generator 125 encrypts the second captured image with the encryption key to generate an encrypted image.

The image transmitter 126 transmits the encrypted image, the permutation matrix, and the restoration key image to the manager terminal 150.

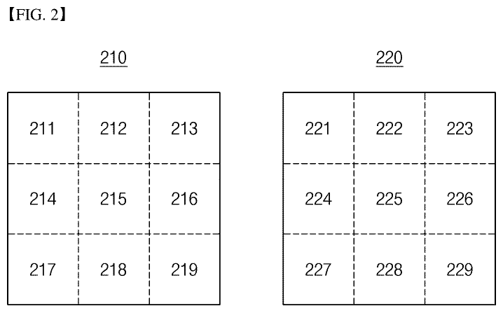

The operations of the image segmentation unit 121, the restoration key image generator 122, the mapping matrix generator 123, the permutation matrix generator 124, the encrypted image generator 125, and the image transmitter 126 are described in detail below with reference to FIG. 2, by way of example.

First, it is assumed that n is ‘3’ and k is ‘4’, and a request for provision of ‘dangerous goods information 3’ which is any one of the dangerous goods informations stored in the dangerous goods information database 111 shown in the Table 1 has been received from the manager terminal 150 to the dangerous goods information management server 110.

The image segmentation unit 121 may extract the ‘dangerous goods information 3’ from the dangerous goods information database 111 shown in the Table 1 and segment a ‘captured image 3’ included in the ‘dangerous goods information 3’ into ‘3×3’ partial regions including ‘three’ horizontal regions and ‘three’ vertical regions.

In this regard, if the ‘captured image 3’ is represented by a reference numeral 210 of FIG. 2, the image segmentation unit 121 may segment the ‘captured image 3 (210)’ into ‘nine’ partial regions 211, 212, 213, 214, 215, 216, 217, 218 and 219 including ‘three’ horizontal regions and ‘three’ vertical regions.

Then, the restoration key image generator 122 may randomly select ‘four’ first partial regions from among the ‘nine’ partial regions 211, 212, 213, 214, 215, 216, 217, 218 and 219.

In this instance, when partial regions 212, 216, 217 and 219 are selected from among the ‘nine’ partial regions 211, 212, 213, 214, 215, 216, 217, 218 and 219, the restoration key image generator 122 may randomly select an odd number of first pixels for each of the first partial regions 212, 216, 217 and 219.

As a result, when ‘17, 21, 9 and 35’ first pixels are selected for each of the first partial regions 212, 216, 217 and 219, the restoration key image generator 122 may randomly change a pixel value for each of the first pixels selected for each of the first partial regions.

The restoration key image generator 122 may also randomly select an even number of second pixels for each of remaining ‘five’ second partial regions 211, 213, 214, 215 and 218 excluding the first partial regions 212, 216, 217 and 219 from the ‘nine’ partial regions 211, 212, 213, 214, 215, 216, 217, 218 and 219.

As a result, when ‘30, 12, 26, 4 and 18’ second pixels are selected for each of the second partial regions 211, 213, 214, 215 and 218, the restoration key image generator 122 may randomly change a pixel value for each of the second pixels selected for each of the second partial regions.

As above, the restoration key image generator 122 can generate a restoration key image by changing the pixel values for the first partial regions 212, 216, 217 and 219 and the second partial regions 211, 213, 214, 215 and 218.

Afterwards, the mapping matrix generator 123 may allocate an element of ‘1’ to the same points as the first partial regions 212, 216, 217 and 219 among the ‘nine’ partial regions 211, 212, 213, 214, 215, 216, 217, 218 and 219 and allocate an element of ‘0’ to the same points as the second partial regions 211, 213, 214, 215 and 218 to thereby generate a mapping matrix

$$‘ ( \begin{matrix}0 & 1 & 0 \\ 0 & 0 & 1 \\ 1 & 0 & 1\end{matrix} ) ’$$

of size 3×3 including ‘0’ and ‘1’.

Then, the permutation matrix generator 124 may split data for ‘location information 3’ included in the ‘dangerous goods information 3’ into ‘four’ pieces to generate ‘four’ split data ‘P₁, P₂, P₃ and P₄’ and may randomly generate ‘five’ dummy data ‘D₁, D₂, D₃, D₄ and D₅’.

Afterwards, the permutation matrix generator 124 may insert the ‘four’ split data ‘P₁, P₂, P₃ and P₄’ one by one at points where the elements of ‘1’ among the ‘nine’ elements constituting the mapping matrix

$$‘ ( \begin{matrix}0 & 1 & 0 \\ 0 & 0 & 1 \\ 1 & 0 & 1\end{matrix} ) ’$$

are located, and insert the ‘five’ dummy data ‘D₁, D₂, D₃, D₄ and D₅’ one by one at points where the elements of ‘0’ are located to thereby generate a permutation matrix

$$‘ ( \begin{matrix}{D}_{1} & {P}_{1} & {D}_{2} \\ {D}_{3} & {D}_{4} & {P}_{2} \\ {P}_{3} & {D}_{5} & {P}_{4}\end{matrix} ) ’$$

of size 3×3.

Then, the encrypted image generator 125 may encrypt the ‘captured image 3 (210)’ with an ‘encryption key of 1’ to generate an encrypted image.

Then, the image transmitter 126 may transmit the encrypted image, the permutation matrix

$$‘ ( \begin{matrix}{D}_{1} & {P}_{1} & {D}_{2} \\ {D}_{3} & {D}_{4} & {P}_{2} \\ {P}_{3} & {D}_{5} & {P}_{4}\end{matrix} ) ’$$

and the restoration key image to the manager terminal 150.

In this instance, when the manager terminal 150 pre-stores the encryption key on a memory and receives the encrypted image, the permutation matrix, and the restoration key image from the dangerous goods information management server 110, the manager terminal 150 restores the second captured image by decrypting the encrypted image with the encryption key, and then extracts the k pieces of split data inserted into the permutation matrix based on the second captured image and the restoration key image. Then, the manager terminal 150 restores data for the second location information by combining the extracted k pieces of split data.

In this instance, according to an embodiment of the present disclosure, when the manager terminal 150 pre-stores the encryption key on a memory and receives the encrypted image, the permutation matrix, and the restoration key image from the dangerous goods information management server 110, the manager terminal 150 restores the second captured image by decrypting the encrypted image with the encryption key, and then segments each of the second captured image and the restoration key image into nxn partial regions including n horizontal regions and n vertical regions. Then, the manager terminal 150 checks the number of pixels with pixel values that are mismatched between the second captured image and the restoration key image for each of the nxn partial regions and generates a region matrix of size n×n including, as elements, the number of pixels with mismatched pixel values checked for each partial region. Then, the manager terminal 150 generates a restoration matrix of size n×n including ‘0’ and ‘1’ by replacing each of the elements constituting the region matrix with a result value when the modulo-2 operation is performed on each element. Then, the manager terminal 150 generates an operation matrix by calculating the Hadamard product between the restoration matrix and the permutation matrix and extracts k non-zero elements among nxn elements constituting the operation matrix as the k pieces of split data. Then the manager terminal 150 restores data for the second location information by combining the extracted k pieces of split data.

Here, the modulo-2 operation refers to an operation that performs division by dividing the dividend by 2 and calculates the remainder.

The Hadamard product refers to an operation of multiplying respective elements in matrices of the same size. When there are matrices ‘[a b c]’ and ‘[x y z]’ and the Hadamard product between the two matrices is calculated, an operation matrix for this may be expressed as ‘[ax by cz]’.

The operation of the manager terminal 150 is described in detail below with reference to FIG. 2, by way of example.

First, as described above, it is assumed that n is ‘3’, k is ‘4’, the ‘encryption key 1’ which is the encryption key pre-shared with the dangerous goods information management server 110 is pre-stored on the memory of the manager terminal 150, and the manager terminal 150 receives the encrypted image, the permutation matrix

$$‘ ( \begin{matrix}{D}_{1} & {P}_{1} & {D}_{2} \\ {D}_{3} & {D}_{4} & {P}_{2} \\ {P}_{3} & {D}_{5} & {P}_{4}\end{matrix} ) ’ ,$$

and the restoration key image as the image transmitter 126 transmits the encrypted image, the permutation matrix

$$‘ ( \begin{matrix}{D}_{1} & {P}_{1} & {D}_{2} \\ {D}_{3} & {D}_{4} & {P}_{2} \\ {P}_{3} & {D}_{5} & {P}_{4}\end{matrix} ) ’ ,$$

and the restoration key image to the manager terminal 150.

It is also assumed that the restoration key image is represented by a reference numeral 220 of FIG. 2.

In this instance, according to the above-described example, the encrypted image is an image generated by encrypting the ‘captured image 3 (210)’ with the ‘encryption key 1’. Therefore, the manager terminal 150 can restore the ‘captured image 3 (210)’ by decrypting the encrypted image with the ‘encryption key 1’.

Afterwards, the manager terminal 150 may segment the ‘captured image 3 (210)’ into ‘nine’ partial regions 211, 212, 213, 214, 215, 216, 217, 218 and 219 including ‘three’ horizontal regions and ‘three’ vertical regions and may segment the restoration key image 220 into ‘nine’ partial regions 221, 222, 223, 224, 225, 226, 227, 228 and 229 including ‘three’ horizontal regions and ‘three’ vertical regions.

Then, the manager terminal 150 may check the number of pixels with pixel values that are mismatched between the ‘captured image 3 (210)’ and the restoration key image 220 for each of the ‘nine’ partial regions.

In this regard, in the case of the ‘partial region 1 (221)’ constituting the restoration key image 220, the pixel values for each of the ‘30’ second pixels have been randomly changed in the ‘partial region 1 (211)’ constituting the ‘captured image 3 (210)’. Therefore, the manager terminal 150 may check the number of pixels with pixel values that are mismatched between the ‘partial region 1 (211)’ and the ‘partial region 1 (221)’, as ‘30’.

And, in the case of the ‘partial region 2 (222)’ constituting the restoration key image 220, the pixel values for each of the ‘17’ first pixels have been randomly changed in the ‘partial region 2 (212)’ constituting the ‘captured image 3 (210)’. Therefore, the manager terminal 150 may check the number of pixels with pixel values that are mismatched between the ‘partial region 2 (212)’ and the ‘partial region 2 (222)’, as ‘17’.

And, in the case of the ‘partial region 3 (223)’ constituting the restoration key image 220, the pixel values for each of the ‘12’ second pixels have been randomly changed in the ‘partial region 3 (213)’ constituting the ‘captured image 3 (210)’. Therefore, the manager terminal 150 may check the number of pixels with pixel values that are mismatched between the ‘partial region 3 (213)’ and the ‘partial region 3 (223)’, as ‘12’.

And, in the case of the ‘partial region 4 (224)’ constituting the restoration key image 220, the pixel values for each of the ‘26’ second pixels have been randomly changed in the ‘partial region 4 (214)’ constituting the ‘captured image 3 (210)’. Therefore, the manager terminal 150 may check the number of pixels with pixel values that are mismatched between the ‘partial region 4 (214)’ and the ‘partial region 4 (224)’, as ‘26’.

And, in the case of the ‘partial region 5 (225)’ constituting the restoration key image 220, the pixel values for each of the ‘4’ second pixels have been randomly changed in the ‘partial region 5 (215)’ constituting the ‘captured image 3 (210)’. Therefore, the manager terminal 150 may check the number of pixels with pixel values that are mismatched between the ‘partial region 5 (215)’ and the ‘partial region 5 (225)’, as ‘4’.

And, in the case of the ‘partial region 6 (226)’ constituting the restoration key image 220, the pixel values for each of the ‘21’ first pixels have been randomly changed in the ‘partial region 6 (216)’ constituting the ‘captured image 3 (210)’. Therefore, the manager terminal 150 may check the number of pixels with pixel values that are mismatched between the ‘partial region 6 (216)’ and the ‘partial region 6 (226)’, as ‘21’.

And, in the case of the ‘partial region 7 (227)’ constituting the restoration key image 220, the pixel values for each of the ‘9’ first pixels have been randomly changed in the ‘partial region 7 (217)’ constituting the ‘captured image 3 (210)’. Therefore, the manager terminal 150 may check the number of pixels with pixel values that are mismatched between the ‘partial region 7 (217)’ and the ‘partial region 7 (227)’, as ‘9’.

And, in the case of the ‘partial region 8 (228)’ constituting the restoration key image 220, the pixel values for each of the ‘18’ second pixels have been randomly changed in the ‘partial region 8 (218)’ constituting the ‘captured image 3 (210)’. Therefore, the manager terminal 150 may check the number of pixels with pixel values that are mismatched between the ‘partial region 8 (218)’ and the ‘partial region 8 (228)’, as ‘18’.

And, in the case of the ‘partial region 9 (229)’ constituting the restoration key image 220, the pixel values for each of the ‘35’ first pixels have been randomly changed in the ‘partial region 9 (219)’ constituting the ‘captured image 3 (210)’. Therefore, the manager terminal 150 may check the number of pixels with pixel values that are mismatched between the ‘partial region 9 (219)’ and the ‘partial region 9 (229)’, as ‘35’.

As above, if the manager terminal 150 checks the number of pixels with pixel values that are mismatched for each partial region, the manager terminal 150 may generate a region matrix

$$‘ ( \begin{matrix}30 & 17 & 12 \\ 26 & 4 & 21 \\ 9 & 18 & 35\end{matrix} ) ’$$

of size 3×3 including, as elements, ‘30, 17, 12, 26, 4, 21, 9, 18 and 35’ that are the number of pixels with the mismatched pixel values checked for each partial region.

Then, the manager terminal 150 may generate a restoration matrix

$$‘ ( \begin{matrix}0 & 1 & 0 \\ 0 & 0 & 1 \\ 1 & 0 & 1\end{matrix} ) ’$$

of size 3×3 including ‘0’ and ‘1’ by replacing each of the elements constituting the region matrix

$$‘ ( \begin{matrix}30 & 17 & 12 \\ 26 & 4 & 21 \\ 9 & 18 & 35\end{matrix} ) ’$$

with a result value when the modulo-2 operation is performed on each element.

Afterwards, the manager terminal 150 may generate an operation matrix

$$‘ ( \begin{matrix}0 & {P}_{1} & 0 \\ 0 & 0 & {P}_{2} \\ {P}_{3} & 0 & {P}_{4}\end{matrix} ) ’$$

by calculating the Hadamard product between the restoration matrix

$$‘ ( \begin{matrix}0 & 1 & 0 \\ 0 & 0 & 1 \\ 1 & 0 & 1\end{matrix} ) ’$$

and the permutation matrix

$$‘ ( \begin{matrix}{D}_{1} & {P}_{1} & {D}_{2} \\ {D}_{3} & {D}_{4} & {P}_{2} \\ {P}_{3} & {D}_{5} & {P}_{4}\end{matrix} ) ’ .$$

In this instance, since ‘four’ non-zero elements among ‘nine’ elements constituting the operation matrix

$$‘ ( \begin{matrix}0 & {P}_{1} & 0 \\ 0 & 0 & {P}_{2} \\ {P}_{3} & 0 & {P}_{4}\end{matrix} ) ’$$

are ‘P₁, P₂, P₃ and P₄’, the manager terminal 150 may extract ‘P₁, P₂, P₃ and P₄’ as four split data.

In this instance, the manager terminal 150 may extract the ‘four’ non-zero elements among the ‘nine’ elements constituting the operation matrix as the four split data one by one sequentially from the left column to the right column and from the top row to the bottom row. That is, the manager terminal 150 may extract the four split data ‘P₁, P₂, P₃ and P₄’ one by one by extracting the ‘four’ non-zero elements among the ‘nine’ elements constituting the operation matrix one by one in the following order: 1st row and 1st column, 1st row and 2nd column, 1st row and 3rd column, 2nd row and 1st column, 2nd row and 2nd column, 2nd row and 3rd column, 3rd row and 1st column, 3rd row and 2nd column, and 3rd row and 3rd column.

Then, the manager terminal 150 may restore data for the ‘location information 3’ by combining the extracted four split data ‘P₁, P₂, P₃ and P₄’.

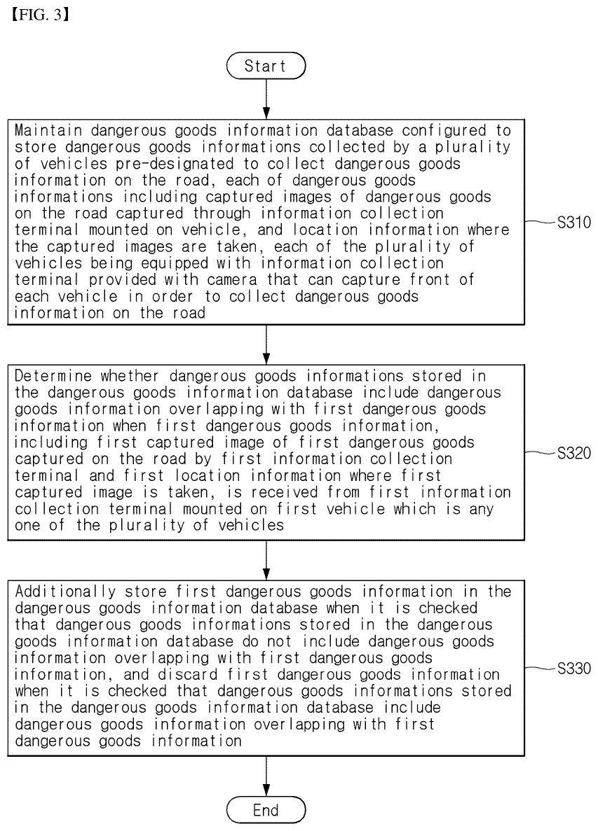

FIG. 3 is a flowchart illustrating an operation method of a dangerous goods information management server capable of collecting and managing dangerous goods information on the road through interworking with an information collection terminal mounted on a vehicle according to an embodiment of the present disclosure.

In step S310, the method maintains a dangerous goods information database that stores dangerous goods informations (each of the dangerous goods informations includes captured images of dangerous goods on the road captured through an information collection terminal mounted on a vehicle, and location information where the captured images are taken) collected by a plurality of vehicles (each of the plurality of vehicles is equipped with an information collection terminal provided with a camera that can capture the front of each vehicle in order to collect the dangerous goods information on the road) pre-designated to collect dangerous goods information on the road.

In step S320, when first dangerous goods information (including a first captured image of a first dangerous goods captured on the road by a first information collection terminal and first location information where the first captured image is taken) is received from the first information collection terminal mounted on a first vehicle which is any one of the plurality of vehicles, the method determines whether the dangerous goods informations stored in the dangerous goods information database include dangerous goods information overlapping with the first dangerous goods information.

In step S330, the method additionally stores the first dangerous goods information in the dangerous goods information database when it is checked that the dangerous goods informations stored in the dangerous goods information database do not include the dangerous goods information overlapping with the first dangerous goods information, and the method discards the first dangerous goods information when it is checked that the dangerous goods informations stored in the dangerous goods information database include the dangerous goods information overlapping with the first dangerous goods information.

According to an embodiment of the present disclosure, the step S320 may comprise, when the first dangerous goods information is received from the first information collection terminal, a step of extracting at least one candidate dangerous goods information including location information, in which a separation distance from the first location information is within a preset reference distance, from the dangerous goods informations stored in the dangerous goods information database; when the at least one candidate dangerous goods information is extracted, a step of calculating an image similarity corresponding to each of the at least one candidate dangerous goods information by calculating an image similarity between a captured image included in each of the at least one candidate dangerous goods information and the first captured image; and a step of checking whether the image similarity corresponding to each of the at least one candidate dangerous goods information exceeds a preset reference similarity when the image similarity corresponding to each of the at least one candidate dangerous goods information is calculated, determining that the dangerous goods informations stored in the dangerous goods information database include dangerous goods information overlapping with the first dangerous goods information when it is checked that the image similarity corresponding to each of the at least one candidate dangerous goods information includes an image similarity exceeding the reference similarity, and determining that the dangerous goods informations stored in the dangerous goods information database do not include dangerous goods information overlapping with the first dangerous goods information when it is checked that the image similarity corresponding to each of the at least one candidate dangerous goods information does not include the image similarity exceeding the reference similarity.

According to an embodiment of the present disclosure, the step of calculating the image similarity corresponding to each of the at least one candidate dangerous goods information may comprise, when the at least one candidate dangerous goods information is extracted, a step of calculating an image histogram for each color channel for each of the captured image included in each of the at least one candidate dangerous goods information and the first captured image; when the image histogram for each color channel for each of the captured image included in each of the at least one candidate dangerous goods information and the first captured image is calculated, a step of calculating a vector similarity for each color channel of each of the at least one candidate dangerous goods information by calculating a vector similarity for each color channel between a vector having, as a component, the number of pixels per pixel value included in the image histogram for the captured image included in each of the at least one candidate dangerous goods information and a vector having, as a component, the number of pixels per pixel value included in an image histogram for the first captured image; and when the vector similarity for each color channel of each of the at least one candidate dangerous goods information is calculated, a step of calculating the image similarity corresponding to each of the at least one candidate dangerous goods information by calculating an average value of the vector similarity for each color channel of each of the at least one candidate dangerous goods information using the image similarity between the captured image included in each candidate dangerous goods information and the first captured image.

According to an embodiment of the present disclosure, the operation method of the dangerous goods information management server may comprise a step of maintaining an encryption key storage unit storing an encryption key that is pre-shared with a manager terminal; when a request for provision of second dangerous goods information which is any one of the dangerous goods informations stored in the dangerous goods information database is received from the manager terminal, a step of extracting the second dangerous goods information from the dangerous goods information database and segmenting a second captured image included in the second dangerous goods information into nxn partial regions including n horizontal regions and n vertical regions, where n is a natural number greater than or equal to 2; a step of generating a restoration key image by randomly selecting k first partial regions from among the n×n partial regions constituting the second captured image, where k is a natural number greater than or equal to 2 and less than n², randomly selecting an odd number of first pixels for each of the first partial regions, randomly changing a pixel value for each of the first pixels selected for each of the first partial regions, randomly selecting an even number of second pixels for each of remaining (n²-k) second partial regions excluding the first partial regions from the n×n partial regions, randomly changing a pixel value for each of the second pixels selected for each of the second partial regions; when the restoration key image is generated, a step of generating a mapping matrix of size n×n including ‘0’ and ‘1’ by allocating an element of ‘1’ to the same points as the first partial regions among the n×n partial regions and allocating an element of ‘0’ to the same points as the second partial regions; when the mapping matrix is generated, a step of generating a permutation matrix of size n×n by splitting data for second location information included in the second dangerous goods information into k pieces to generate k split data, randomly generating (n²-k) dummy data, inserting the k split data one by one at points where the elements of ‘1’ among the n×n elements constituting the mapping matrix are located, and inserting the (n²-k) dummy data one by one at points where the elements of ‘0’ are located; a step of generating an encrypted image by encrypting the second captured image with the encryption key; and a step of transmitting the encrypted image, the permutation matrix, and the restoration key image to the manager terminal. When the manager terminal pre-stores the encryption key on a memory and receives the encrypted image, the permutation matrix, and the restoration key image from the dangerous goods information management server, the manager terminal may restore the second captured image by decrypting the encrypted image with the encryption key, extract the k split data inserted into the permutation matrix based on the second captured image and the restoration key image, and restore data for the second location information by combining the extracted k split data.

According to an embodiment of the present disclosure, when the manager terminal pre-stores the encryption key on a memory and receives the encrypted image, the permutation matrix, and the restoration key image from the dangerous goods information management server, the manager terminal may restore the second captured image by decrypting the encrypted image with the encryption key, and then segment each of the second captured image and the restoration key image into n×n partial regions including n horizontal regions and n vertical regions. Then, the manager terminal may check the number of pixels with pixel values that are mismatched between the second captured image and the restoration key image for each of the n×n partial regions and generate a region matrix of size n×n including, as elements, the number of pixels with mismatched pixel values checked for each partial region. Then, the manager terminal may generate a restoration matrix of size n×n including ‘0’ and ‘1’ by replacing each of the elements constituting the region matrix with a result value when the modulo-2 operation is performed on each element. Then, the manager terminal may generate an operation matrix by calculating the Hadamard product between the restoration matrix and the permutation matrix and extract k non-zero elements among n×n elements constituting the operation matrix as the k split data. Then the manager terminal may restore data for the second location information by combining the extracted k split data.

So far, the operation method of the dangerous goods information management server capable of collecting and managing the dangerous goods information on the road through interworking with the information collection terminal mounted on a vehicle according to an embodiment of the present disclosure has been described with reference to FIG. 3. The operation method of the dangerous goods information management server according to an embodiment of the present disclosure may correspond to the operation of the dangerous goods information management server 110 described with reference to FIGS. 1 and 2, and thus the more detailed description thereof will be omitted.

The operation method of the dangerous goods information management server according to an embodiment of the present disclosure can be implemented by a computer program stored in a storage medium for execution through combination with a computer.

The operation method of the dangerous goods information management server according to an embodiment of the present disclosure can be implemented in the form of program instructions, that can be executed through various computer means, and can be recorded on a computer readable medium. The computer readable medium may include program instructions, data files, data structures, etc. alone or in combination. The program instructions recorded on the computer readable medium may be specially designed and configured for the present disclosure, or may be known and available to those skilled in the art of computer software. Examples of the computer readable medium include magnetic media such as a hard disk, a floppy disk, and a magnetic tape, optical media such as CD-ROM and DVD, magneto-optical media such as a floptical disk, and a hardware device which is specifically configured to store and execute the program instructions such as ROM, RAM, and a flash memory. Examples of the program instructions include not only machine code, such as that produced by a compiler, but also high-level language code that can be executed by a computer using an interpreter, etc.

As above, although the present disclosure has been described with reference to specific details such as specific components and limited embodiments and drawings, these have been provided only to help a more general understanding of the present disclosure. The present disclosure is not limited to the above embodiments and can be modified and changed in various ways from the above description by those skilled in the art to which the present disclosure pertains

Accordingly, the idea of the present disclosure should not be limited to the above-described embodiments, and all things that are equivalent to the claims described below as well as the claims are included in the scope of the idea of the present disclosure.

1-22. (canceled)

23. A method of generating dangerous goods information, the method comprising:
pre-storing, by one or more processors, dangerous goods information including a road image and location information corresponding to the road image in a database;
receiving, by the one or more processors, first dangerous goods information including a first road image and first location information corresponding to the first road image collected by a moving entity;
extracting, by the one or more processors, candidate dangerous goods information including location information, that is within a predetermined distance from the first location information, from the database based on the first location information of the received first dangerous goods information; and
determining, by the one or more processors, a similarity between a road image of the extracted candidate dangerous goods information and the first road image of the first dangerous goods information; and
storing, by the one or more processors based on the similarity, the first dangerous goods information in the database and generating an encrypted image, a permutation matrix, and a restoration key image corresponding to the first dangerous goods information, allowing another device to restore the first dangerous goods information using the encrypted image, the permutation matrix and the restoration key image.

24. The method of claim 23, wherein determining the similarity comprises:
calculating an image histogram for each color channel for each of the road image of the candidate dangerous goods information and the first road image of the first dangerous goods information;
calculating a vector similarity between a vector having, as a component, a number of pixels per pixel value included in the image histogram calculated for the road image of the candidate dangerous goods information and a vector having, as a component, a number of pixels per pixel value included in the image histogram calculated for the first road image of the first dangerous goods information to obtain a vector similarity for each color channel of each of the candidate dangerous goods information; and
calculating an image similarity between the road image of the candidate dangerous goods information and the first road image of the first dangerous goods information based on the obtained vector similarity for each color channel.

25. The method of claim 23, further comprising:
processing, by the one or more processors, the first dangerous goods information based on a result of determining the similarity so that overlap data is not present in the database.

26. The method of claim 25, wherein processing the first dangerous goods information comprises:
determining, based on the result of determining the similarity, that the overlap data is present in the database, and discarding the first dangerous goods information.

27. The method of claim 25, wherein storing the first dangerous goods information in the database comprises:
determining, based on the result of determining the similarity, that the overlap data is not present in the database, and storing the first dangerous goods information in the database.

28. The method of claim 23, wherein generating the encrypted image, the permutation matrix, and the restoration key image comprises:
receiving a request for the first dangerous goods information stored in the database from a manager terminal, and segmenting, by the one or more processors, the first road image included in the first dangerous goods information into a plurality of partial regions;
generating, by the one or more processors, the restoration key image by randomly selecting first pixels for each of first partial regions randomly selected from among the plurality of partial regions and then randomly changing a pixel value for each of the first pixels, and randomly selecting second pixels for each of remaining second partial regions excluding the first partial regions from the plurality of partial regions and then randomly changing a pixel value for each of the second pixels;
allocating, by the one or more processors, a first element to the same points as the first partial regions of the plurality of partial regions and allocating a second element to the same points as the second partial regions to generate a mapping matrix including the first element and the second element;
generating, by the one or more processors, the permutation matrix by splitting data for the first location information included in the first dangerous goods information into a number of the first partial regions to generate split data, generating dummy data as many as a number of the second partial regions, inserting the split data one by one at points where the first element among elements constituting the mapping matrix is located, and inserting the dummy data one by one at points where the second element is located;
generating, by the one or more processors, the encrypted image by encrypting the first road image with an encryption key that is pre-shared with the manager terminal; and
transmitting, by the one or more processors, the encrypted image, the permutation matrix, and the restoration key image to the manager terminal.

29. The method of claim 28, wherein transmitting the encrypted image, the permutation matrix, and the restoration key image to the manager terminal comprises:
allowing the manager terminal to restore the first road image by decrypting the encrypted image with the pre-stored encryption key and then restore data for the first location information by extracting and combining the split data inserted into the permutation matrix based on the first road image and the restoration key image.

30. A device for generating dangerous goods information, comprising:
a memory configured to store one or more instructions managing dangerous goods information; and
one or more processors configured to execute the one or more instructions stored in the memory,
wherein the one or more processors are configured to:
pre-store dangerous goods information including a road image and location information corresponding to the road image in a database;
receive first dangerous goods information including a first road image and first location information corresponding to the first road image collected by a moving entity;
extract candidate dangerous goods information including location information, that is within a predetermined distance from the first location information, from the database based on the first location information of the received first dangerous goods information;
determine a similarity between a road image of the extracted candidate dangerous goods information and the first road image of the first dangerous goods information; and
store, based on the similarity, the first dangerous goods information in the database and generate an encrypted image, a permutation matrix, and a restoration key image corresponding to the first dangerous goods information, allowing another device to restore the first dangerous goods information using the encrypted image, the permutation matrix and the restoration key image.

31. The device of claim 30, wherein the one or more processors are further configured to:
calculate an image histogram for each color channel for each of the road image of the candidate dangerous goods information and the first road image of the first dangerous goods information;
calculate a vector similarity between a vector having, as a component, a number of pixels per pixel value included in the image histogram calculated for the road image of the candidate dangerous goods information and a vector having, as a component, a number of pixels per pixel value included in the image histogram calculated for the first road image of the first dangerous goods information to obtain a vector similarity for each color channel of each of the candidate dangerous goods information; and
calculate an image similarity between the road image of the candidate dangerous goods information and the first road image of the first dangerous goods information based on the obtained vector similarity for each color channel.

32. The device of claim 30, wherein the one or more processors are further configured to:
process the first dangerous goods information based on a result of determining the similarity so that overlap data is not present in the database.

33. The device of claim 32, wherein in processing the first dangerous goods information, the one or more processors are configured to:
determine, based on the result of determining the similarity, that the overlap data is present in the database, and discard the first dangerous goods information.

34. The device of claim 32, wherein in storing the first dangerous goods information in the database comprises, the one or more processors are configured to:
determine, based on the result of determining the similarity, that the overlap data is not present in the database, and store the first dangerous goods information in the database.

35. The device of claim 30, wherein in generating the encrypted image, the permutation matrix, and the restoration key image, the one or more processors are configured to:
receive a request for the first dangerous goods information stored in the database from a manager terminal, and segmenting, by the one or more processors, the first road image included in the first dangerous goods information into a plurality of partial regions;
generate the restoration key image by randomly selecting first pixels for each of first partial regions randomly selected from among the plurality of partial regions and then randomly changing a pixel value for each of the first pixels, and randomly selecting second pixels for each of remaining second partial regions excluding the first partial regions from the plurality of partial regions and then randomly changing a pixel value for each of the second pixels;
allocate a first element to the same points as the first partial regions of the plurality of partial regions and allocating a second element to the same points as the second partial regions to generate a mapping matrix including the first element and the second element;
generate the permutation matrix by splitting data for the first location information included in the first dangerous goods information into a number of the first partial regions to generate split data, generating dummy data as many as a number of the second partial regions, inserting the split data one by one at points where the first element among elements constituting the mapping matrix is located, and inserting the dummy data one by one at points where the second element is located;
generate the encrypted image by encrypting the first road image with an encryption key that is pre-shared with the manager terminal; and
transmit the encrypted image, the permutation matrix, and the restoration key image to the manager terminal.

36. The device of claim 35, wherein in transmitting the encrypted image, the permutation matrix, and the restoration key image to the manager terminal, the one or more processors are configured to:
allow the manager terminal to restore the first road image by decrypting the encrypted image with the pre-stored encryption key and then restore data for the first location information by extracting and combining the split data inserted into the permutation matrix based on the first road image and the restoration key image.

37. One or more non-transitory computer readable mediums storing one or more instructions,
wherein the one or more instructions executable by one or more processors are configured to:
pre-store dangerous goods information including a road image and location information corresponding to the road image in a database;
receive first dangerous goods information including a first road image and first location information corresponding to the first road image collected by a moving entity;
extract candidate dangerous goods information including location information, that is within a predetermined distance from the first location information, from the database based on the first location information of the received first dangerous goods information;
determine a similarity between a road image of the extracted candidate dangerous goods information and the first road image of the first dangerous goods information; and
store, based on the similarity, the first dangerous goods information in the database and generate an encrypted image, a permutation matrix, and a restoration key image corresponding to the first dangerous goods information, allowing another device to restore the first dangerous goods information using the encrypted image, the permutation matrix and the restoration key image.

38. The one or more non-transitory computer readable mediums of claim 37,
wherein the one or more instructions are further configured to:
calculate an image histogram for each color channel for each of the road image of the candidate dangerous goods information and the first road image of the first dangerous goods information;
calculate a vector similarity between a vector having, as a component, a number of pixels per pixel value included in the image histogram calculated for the road image of the candidate dangerous goods information and a vector having, as a component, a number of pixels per pixel value included in the image histogram calculated for the first road image of the first dangerous goods information to obtain a vector similarity for each color channel of each of the candidate dangerous goods information; and
calculate an image similarity between the road image of the candidate dangerous goods information and the first road image of the first dangerous goods information based on the obtained vector similarity for each color channel.

39. The one or more non-transitory computer readable mediums of claim 37,
wherein the one or more instructions are further configured to:
process the first dangerous goods information based on a result of determining the similarity so that overlap data is not present in the database.

40. The one or more non-transitory computer readable mediums of claim 39,
wherein in processing the first dangerous goods information, the one or more instructions are configured to:
determine, based on the result of determining the similarity, that the overlap data is present in the database, and discard the first dangerous goods information.

41. The device of claim 39, wherein in storing the first dangerous goods information in the database comprises, the one or more instructions are configured to:
determine, based on the result of determining the similarity, that the overlap data is not present in the database, and store the first dangerous goods information in the database.

42. The one or more non-transitory computer readable mediums of claim 37,
wherein in generating the encrypted image, the permutation matrix, and the restoration key image, the one or more instructions are configured to:
receive a request for the first dangerous goods information stored in the database from a manager terminal, and segmenting, by the one or more processors, the first road image included in the first dangerous goods information into a plurality of partial regions;
generate the restoration key image by randomly selecting first pixels for each of first partial regions randomly selected from among the plurality of partial regions and then randomly changing a pixel value for each of the first pixels, and randomly selecting second pixels for each of remaining second partial regions excluding the first partial regions from the plurality of partial regions and then randomly changing a pixel value for each of the second pixels;
allocate a first element to the same points as the first partial regions of the plurality of partial regions and allocating a second element to the same points as the second partial regions to generate a mapping matrix including the first element and the second element;
generate the permutation matrix by splitting data for the first location information included in the first dangerous goods information into a number of the first partial regions to generate split data, generating dummy data as many as a number of the second partial regions, inserting the split data one by one at points where the first element among elements constituting the mapping matrix is located, and inserting the dummy data one by one at points where the second element is located;
generate the encrypted image by encrypting the first road image with an encryption key that is pre-shared with the manager terminal; and
transmit the encrypted image, the permutation matrix, and the restoration key image to the manager terminal.
